(19) United States
(12) Patent Application Publication
(10) Pub. No.: US 2015/0246584 A1
(43) Pub. Date: Sep. 3, 2015

(54) TIRE WITH SEGMENTED CONTACT SURFACE

(71) Applicant: Shinji Marui, Kobe (JP)

(72) Inventor: Shinji Marui, Kobe (JP)

(21) Appl. No.: 14/195,618

(22) Filed: Mar. 3, 2014

(51) Int. Cl. B60C 11/03; B60C 11/11

(52) U.S. Cl. CPC B60C 11/0332; B60C 11/11

(57) ABSTRACT

A tire includes a plurality of tire knobs of various shapes arranged to form contact surfaces configured to touch the ground. The contact surface is the radially outermost surface of each knob which may be formed in a variety of three-dimensional structures such as pyramids, wedges, cones, and others. The contact surfaces may be points, lines or a combination of both. The contact surface lines may be segmented as a result of gaps between adjacent knobs that are aligned with each other. The contact surfaces may also be line segments joined to each other at offset angles to form a zig-zag pattern. Each contact surface may be centered or off-centered with respect to the base of the knob.

### BACKGROUND OF THE INVENTION

1. Field of the Invention

The invention relates generally to tires for bicycles and vehicles.

2. Description of Prior Art and Related Information

Tire treads provide grip by generating friction with the ground surface. Too little friction may enable ease of riding with less resistance, such as with a road bicycle, but provide insufficient traction for certain terrains and road conditions. Therefore, a need exists to improve tire friction.

### SUMMARY OF THE INVENTION

In one aspect, embodiments of tires disclosed herein include treads formed of knobs having contact surfaces configured to contact the ground. Such contact surfaces can be formed as segmented contact surface lines where each segmented line comprises a row of linearly aligned ridges formed at the top of each tire knob. Each knob comprises a body that may include a base, or footprint, which may be shaped as a rectangle, an oval or any other shape. Surfaces extend up from the base to form the contact surface of each knob.

In other aspects, the embodiments may include linear knobs joined to each other at offset angles to form a zig-zag contact surface pattern. Other embodiments have contact surfaces that may include both apexes, or points, and lines. The contact surfaces may be centered or off-centered with respect to the base of the knob. The base of each knob may be formed with rectangular or non-rectangular shapes, such as an oval.

### BRIEF DESCRIPTION OF THE DRAWINGS

FIG. 1 is a perspective view of a first preferred embodiment of a tire with segmented contact surface lines;

FIG. 2 is a cross-sectional view of the first preferred embodiment of the tire;

FIG. 3 is another cross-sectional view of the first preferred embodiment of the tire;

FIG. 4 is a perspective view of a second preferred embodiment of a tire with segmented contact surface lines;

FIG. 5 is a cross-sectional view of the second preferred embodiment of the tire;

FIG. 6 is a another cross-sectional view of the second preferred embodiment of the tire;

FIG. 7 is a perspective view of a third preferred embodiment of a tire with segmented contact surface lines;

FIG. 8 is a cross-sectional view of the third preferred embodiment of the tire;

FIG. 9 is a another cross-sectional view of the third preferred embodiment of the tire;

FIG. 10 is a perspective view of a fourth preferred embodiment of a tire contact surfaces;

FIG. 11 is a cross-sectional view of the fourth preferred embodiment of the tire;

FIG. 12 is yet another cross-sectional view of the fourth preferred embodiment of the tire;

FIG. 13 is a perspective view of an fifth preferred embodiment of a tire with contact surfaces;

FIG. 14 is a cross-sectional view of the fifth preferred embodiment of the tire;

FIG. 15 is another cross-sectional view of the fifth preferred embodiment of the tire;

FIG. 16 is a top view of a sixth preferred embodiment of a tire with segmented contact surface lines;

FIG. 17 is a perspective view of the sixth preferred embodiment of the tire;

FIG. 18 is a cross-sectional view of the sixth preferred embodiment of the tire;

FIG. 19 is another cross-sectional view of the sixth preferred embodiment of the tire;

FIG. 20 is a top view of an seventh preferred embodiment of a tire with segmented contact surface lines;

FIG. 21 is a cross-sectional view of the seventh preferred embodiment of the tire;

FIG. 22 is a top view of a eighth preferred embodiment of a tire with segmented contact surface lines;

FIG. 23 is a perspective view of the eighth preferred embodiment of the tire;

FIG. 24 is a cross-sectional view of the eighth preferred embodiment of the tire;

FIG. 25 is another cross-sectional view of the eighth preferred embodiment of the tire;

FIG. 26 is a perspective view of a ninth preferred embodiment of a tire with contact surfaces;

FIG. 27 is a cross-sectional view of the ninth preferred embodiment of the tire;

FIG. 28 is another cross-sectional view of the ninth preferred embodiment of the tire;

FIG. 29 is yet another cross-sectional view of the ninth preferred embodiment of the tire;

FIG. 30 is a top view of the ninth preferred embodiment of the tire.

FIG. 31 is a perspective view of a tenth preferred embodiment of a tire having connected zig-zag contact surface lines;

FIG. 32 is a top view of the tenth preferred embodiment of a tire;

FIG. 33 is a perspective view of an eleventh preferred embodiment of a tire segmented contact surface lines at varying angles;

FIG. 34 is a top view of the eleventh preferred embodiment of the tire;

FIG. 35 is a perspective view of a twelfth preferred embodiment of a tire with knobs each having an oval base and a linear contact surface; and

FIG. 36 is a top view of the twelfth preferred embodiment of a tire with knobs each having an oval base and a linear contact surface.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS

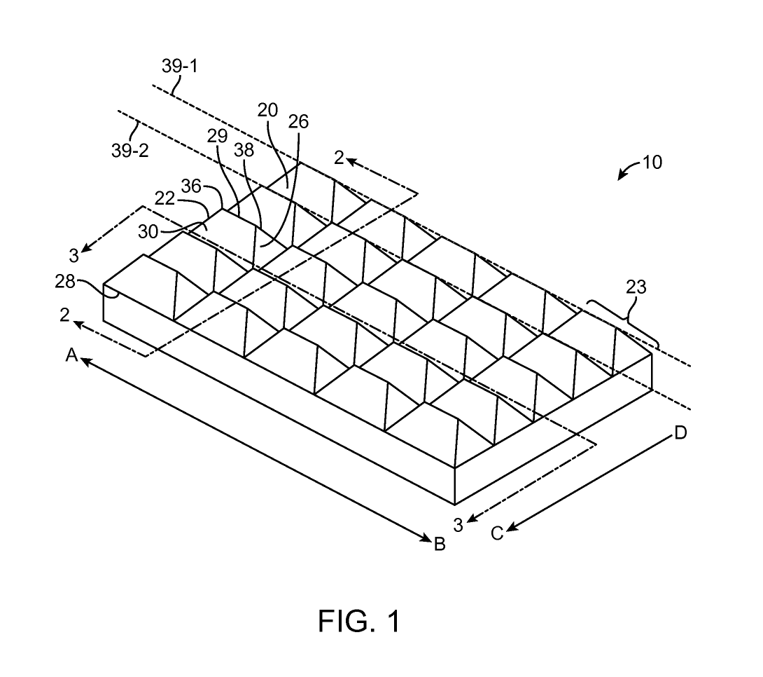

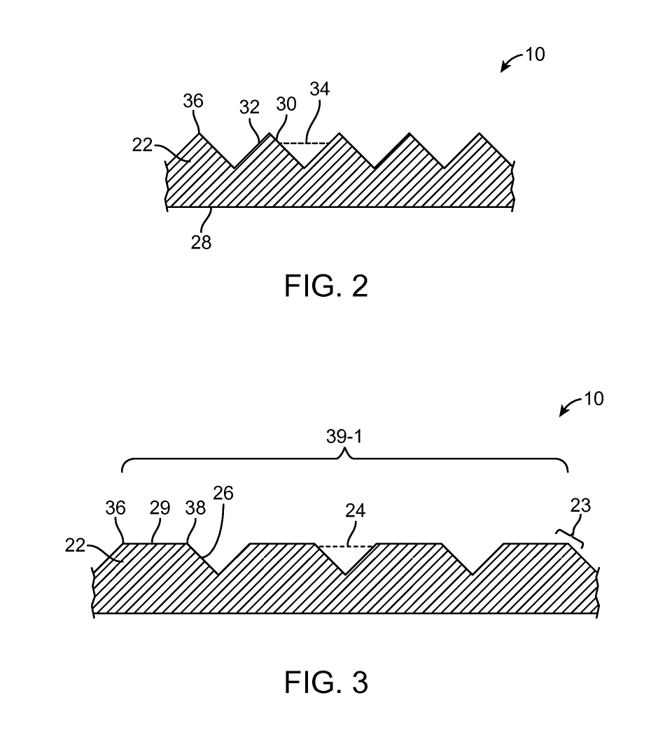

A first preferred embodiment of a tire with contact surfaces is illustrated in FIGS. 1-3 and designated generally by the reference numeral 10. The tire 10 may be configured for use with bicycles, scooters, motorcycles, automobiles, trucks, tractors and any other ground vehicle or toy requiring tires.

Throughout the specification, the positional and directional terms below refer to the following:
“A-B direction” shall refer to the direction of a tire from a sidewall to the opposite sidewall, i.e., the width.
“C-D direction” shall refer to the length-wise direction of a tire.

In a first preferred embodiment shown in FIG. 1, the tire 10 comprises a plurality of tire knobs 20 that collectively form a tread pattern. The knobs 20 may comprise a variety of geometric shapes. According to the first preferred embodiment, all the knobs 20 are preferably identical in structure and aligned in the same direction. Each knob 20 defines a knob top and a knob bottom. The knob bottom, or simply bottom, is attached to or contiguous with the circumferential wall of the tire 10. The knob top is the radially outermost portion of the knob that is configured to contact the ground when the tire 10 rolls. Therefore, the contact surface of each knob comprises the knob top.

In the first preferred embodiment, each knob 20 comprises a geometric wedge 23 defined by a rectangular knob bottom 28, a pair of quadrilateral surfaces 30, 32 that meet at the top to form a contact surface that comprises a ridge 29, along with a pair of triangular ends 22, 26. The triangular ends 22, 26 have respective apexes 36, 38 that are connected by the ridge 29. In this embodiment, the contact surface of each knob is linear. As illustrated, each wedge 23 is preferably symmetrical with two identical opposing quadrilateral surfaces 30, 32, and two identical triangular opposing ends 22, 26, all extending upward from a rectangular bottom 28. In this embodiment, the shape of the quadrilateral surfaces 30, 32 preferably comprises a trapezoid and, more specifically, an isosceles trapezoid.

The knobs 20 are arranged in rows such that the ridges 29 are linearly aligned in order to collectively form an extended contact surface line that is segmented, or simply a segmented contact surface line 39-1, 39-2. Alternatively stated, a segmented contact surface line 39-1, 39-2, comprises a row of linear contact surfaces, i.e., ridges, that are linearly or axially aligned and spaced apart by end gaps.

A first row of knobs 20 is positioned end to end to form a first segmented contact surface line 39-1, which is adjacent to a second row of linearly aligned knobs 20 forming a second segmented contact surface line 39-2. As illustrated in FIGS. 1-3, in one embodiment, the first segmented contact surface line 39-1 comprises a row of symmetrical wedges 23 oriented in the A-B direction, wherein an edge of the triangular end 22 of one symmetrical wedge 23 touches an edge of the triangular end 26 of the adjacent symmetrical wedge 23, creating a linear groove 24 between adjacent wedges 23.

In the first preferred embodiment, a plurality of segmented contact surface lines 39-1, 39-2 are parallel in the A-B direction, wherein an edge of the quadrilateral surface 32 of one symmetrical wedge 23 abuts an edge of the quadrilateral surface 30 of the adjacent symmetrical wedge 23, creating a transversal groove 34 between adjacent wedges 23. It can be appreciated that the combination of the linear groove 24 and the transversal groove 34 provide multiple channels to allow water and particles to pass through the channels and away from the surface of the tread to improve traction of the tire 10 as it rolls over a ground surface.

In an alternative preferred embodiment, a tire may be substantially similar to the first preferred embodiment except that the wedges are oriented in the C-D direction, namely perpendicular to that of the first embodiment.

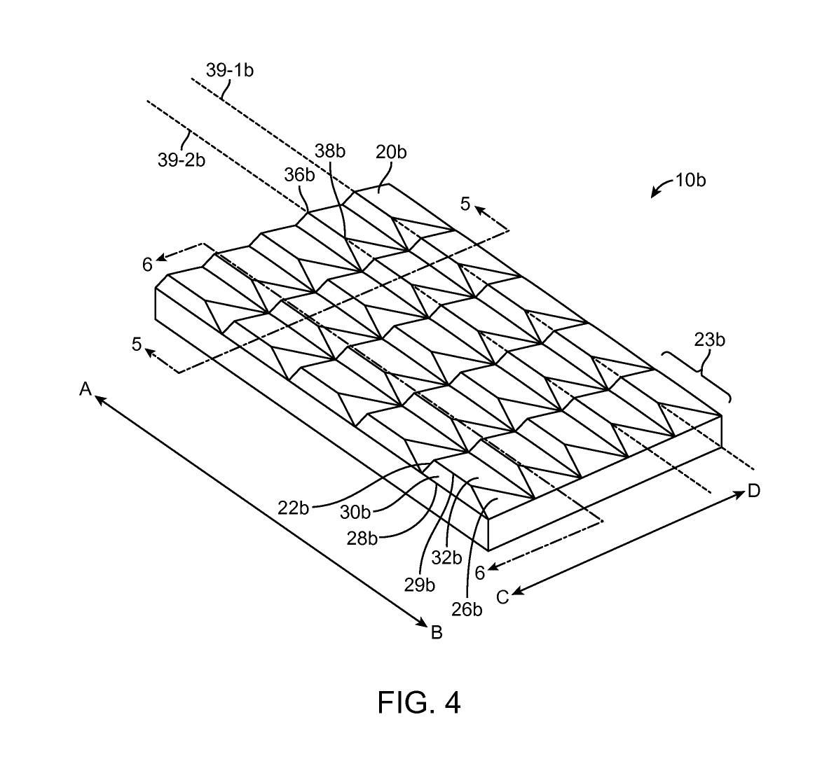

FIGS. 4-6 illustrate a second preferred embodiment of a tire with segmented contact surface 10b, where elements of similar structure are designated by the same reference numerals followed by the lower case “b.”

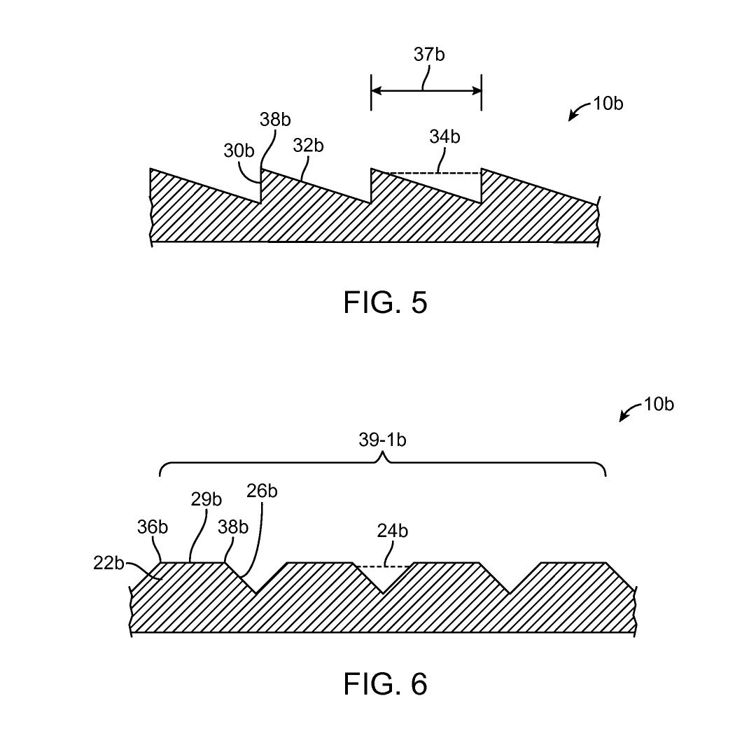

In the second preferred embodiment, the tire 10b comprises a plurality of tire knobs 20b. The knobs 20b are preferably identical in structure and aligned in the same direction. Each knob 20b comprises an asymmetrical geometric wedge 23b defined by a rectangular bottom 28b, a minor quadrilateral surface 30b, a major quadrilateral surface 32b, wherein the quadrilateral surfaces 30b, 32b meet at the top to form a ridge 29b, along with a pair of triangular ends 22b, 26b. The triangular ends 22b, 26b have respective apexes 36b, 38b that are connected by the ridge 29b. The ridge 29b forms the point of contact of the tire 10b with a ground surface. As illustrated, the minor quadrilateral surface 30b has less surface area and a shorter distance from its bottom edge to the ridge 29b than the major quadrilateral surface 32b, such that the ridge 29b is off the center of the rectangular bottom 28b to form the asymmetrical wedge 23b. As shown in FIG. 5, each ridge 29b is preferably off-centered with respect to a midpoint of the width 37b of each knob 20b.

Similar to the first embodiment, the knobs 20b are arranged in rows such that the ridges 29b are linearly aligned in order to collectively form a segmented contact surface line that meets the ground.

A first row of knobs 20b may be positioned end to end to form a first segmented contact surface line 39-1b, which is adjacent to a second row of linearly aligned knobs 20b forming a second segmented contact surface line 39-2b. As illustrated in FIGS. 4-6, in one embodiment, the first segmented contact surface line 39-1b comprises a row of asymmetrical wedges 23b oriented in the A-B direction, wherein an edge of the triangular end 22b of one asymmetrical wedge 23b touches an edge of the triangular end 26b of the adjacent asymmetrical wedge 23b, creating a linear groove 24b between adjacent wedges 23b.

In the second preferred embodiment, a plurality of segmented contact surface lines 39-1b, 39-2b are parallel in the A-B direction and touching each other, wherein an edge of the major quadrilateral surface 32b of one asymmetrical wedge 23b abuts an edge of the minor quadrilateral surface 30b of the adjacent asymmetrical wedge 23b, creating a transversal groove 34b between adjacent wedges 23b. It can be appreciated that the combination of the linear groove 24b and the transversal groove 34b provide multiple channels to allow water and particles to pass through the channels and away from the surface of the tread to improve traction.

In an alternative preferred embodiment, a tire may be substantially similar to the second preferred embodiment except that the knobs are oriented in the C-D direction, namely perpendicular to that of the second embodiment.

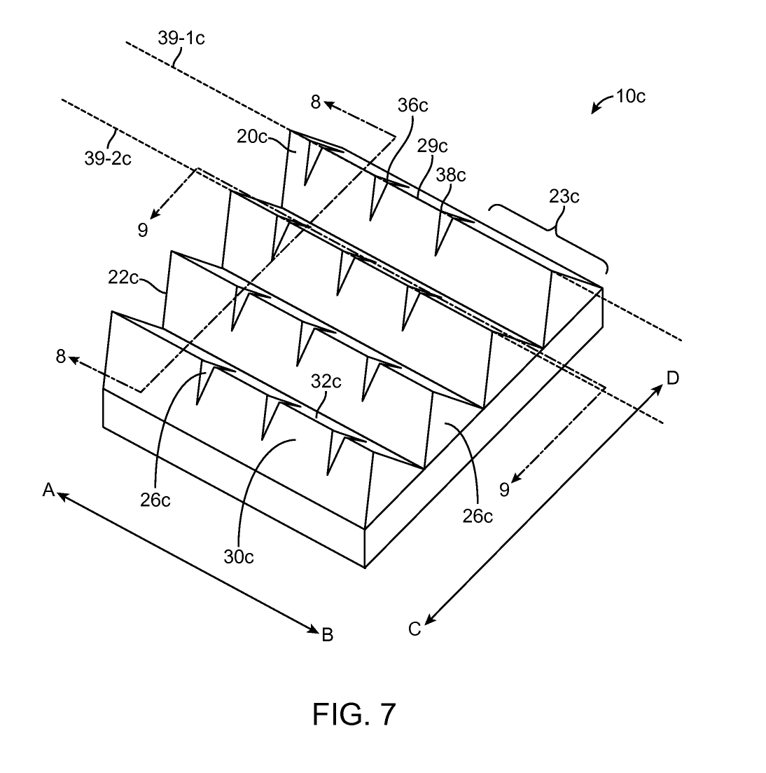

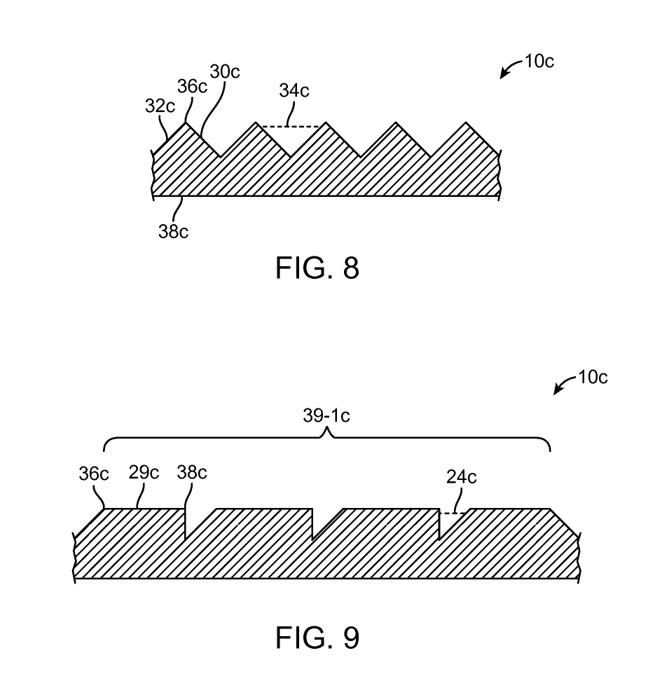

In a third preferred embodiment shown in FIGS. 7-9, a tire with segmented contact surface 10c is provided, where elements of similar structure are designated by the same reference numerals followed by the lower case “c.”

In this third preferred embodiment, the tire 10c comprises a plurality of tire knobs 20c. The knobs 20c are preferably aligned in the same direction. Each knob 20c comprises a geometric wedge 23c defined by a rectangular bottom 28c, a pair of trapezoidal surfaces 30c, 32c that meet at the top to form a ridge 29c, along with a pair of triangular ends 22c, 26c. The triangular ends 22c, 26c have respective apexes 36c, 38c that are connected by the ridge 29c. The ridge 29c forms the point of contact of the tire 10c with a ground surface. In this embodiment, the shape of the trapezoidal surfaces 30c, 32c is not an isosceles trapezoid, but is instead preferably a scalene trapezoid which may include a right trapezoid.

The knobs 20c are arranged in rows such that the ridges 29c are linearly aligned in order to collectively form a segmented contact surface line when the tire 10c meets the ground.

A first row of knobs 20c may be positioned end to end to form a first segmented contact surface line 39-1c, which is adjacent to a second row of linearly aligned knobs 20c forming a second segment contact surface line 39-2c. As illustrated in FIGS. 7-9, in one embodiment, the first segmented contact surface line 39-1c comprises a row of symmetrical wedges 23c oriented in the A-B direction, wherein the respective trapezoidal surfaces 30c of the symmetrical wedges 23c are fused together to form one continuous side surface 31c, the respective trapezoidal surfaces 32c of the symmetrical wedges 23c are fused together to form another continuous side surface 33c, and the adjacent wedges 23c are segmented by linear grooves 24c between ridges 29c that do not entirely bisect from top to bottom.

In the third preferred embodiment, a plurality of segmented contact surface lines 39-1c, 39-2c are parallel in the A-B direction and touching each other, wherein an edge of the trapezoidal surface 32c of one symmetrical wedge 23c abuts an edge of the trapezoidal surface 30c of the adjacent symmetrical wedge 23c, creating a transversal groove 34c between adjacent wedges 23c.

In an alternative preferred embodiment, a tire may be substantially similar to the third preferred embodiment except that the knobs are oriented in the C-D direction, namely perpendicular to that of the third embodiment.

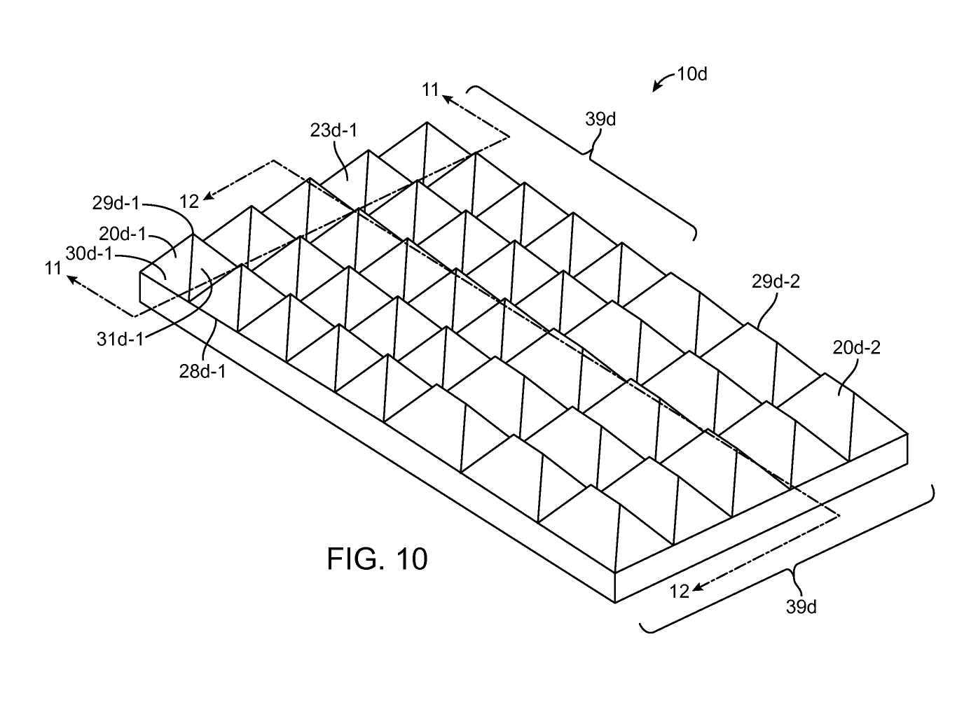

FIGS. 10-12 illustrate a fourth preferred embodiment of a tire 10d where elements of similar structure are designated by the same reference numerals followed by the lower case “d.”

In this embodiment, the tire 10d comprises a first plurality of uniform tire knobs 20d-1 where the contact surfaces 29d-1 comprises apexes. A second plurality of knobs 20d-2 substantially similar to those shown in the first embodiment in FIGS. 1-3, is disposed adjacent to the first plurality of knobs 20d-1. Thus, the second plurality of knobs has contact surfaces that comprise ridges 29d-2.

In the first plurality of knobs 29d-1, each knob 20d-1 comprises a symmetrical pentahedron or a pyramid 23d-1 defined by a square bottom 28d-1, four identical triangular surfaces 30d-1, 31d-1, 33d-1 and 35d-1 that meet at the top at an apex point 29d-1. The apex point 29d-1 forms the point of contact of this portion of the tire 10d with a ground surface.

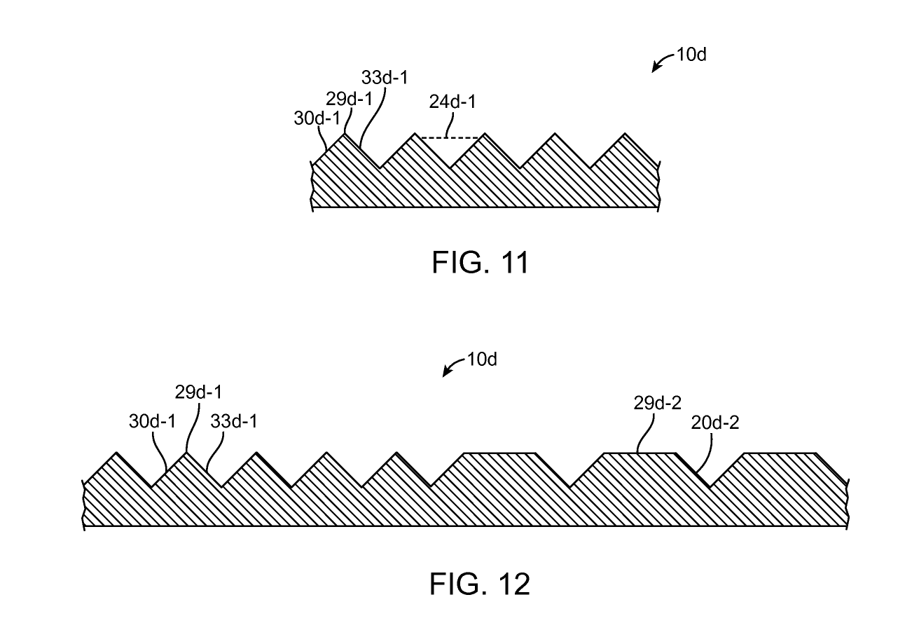

The first plurality of knobs 20d-1 are aligned with the linear ridges 29d-2 in the second plurality in order to collectively form a an extended contact surface that comprises both segmented lines and separate dots in each row. As shown in FIGS. 11-12, as one edge of the pyramid 23d-1 touches another edge of the adjacent pyramid 23d-1, a groove 24d-1 is disposed between apex points 29d-1.

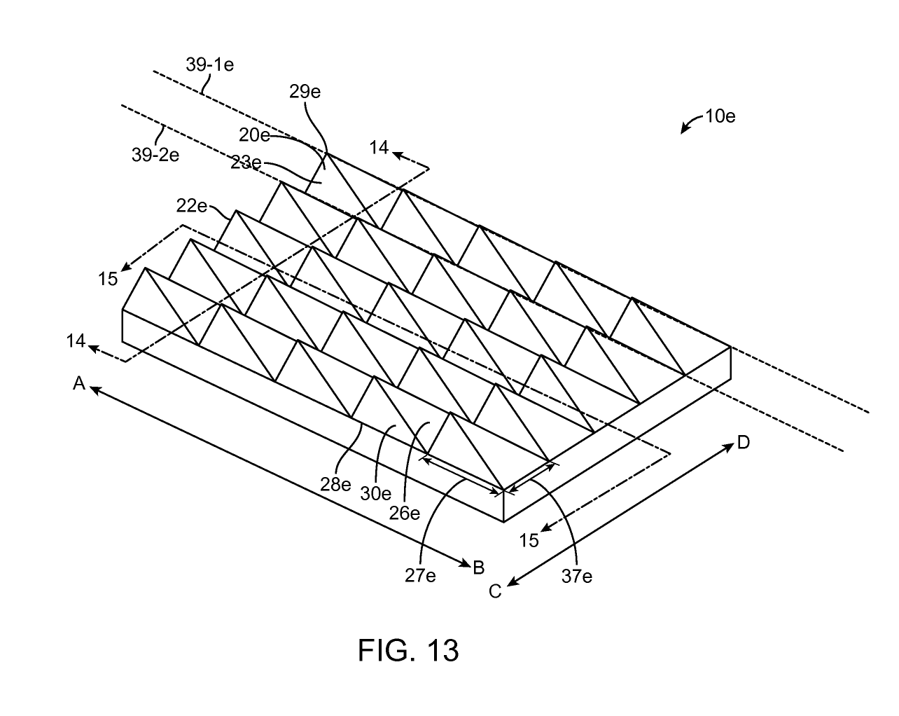

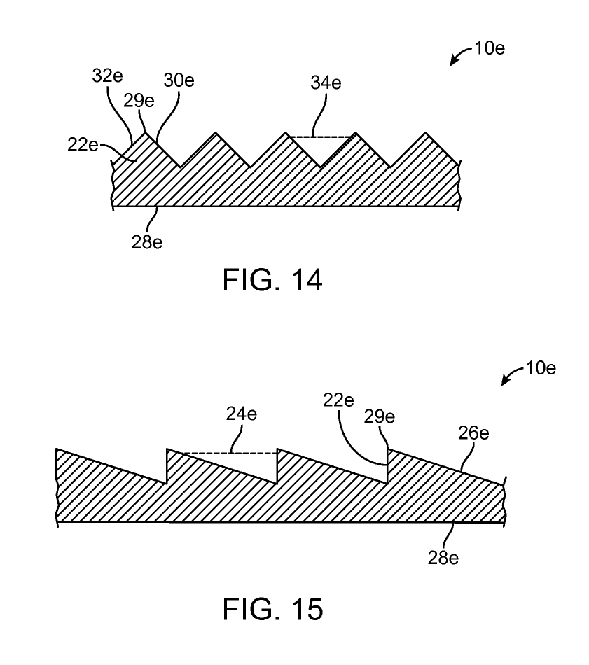

A fifth preferred embodiment shown in FIGS. 13-15 provides a tire 10e, where elements of similar structure are designated by the same reference numerals followed by the lower case “e.”

In this embodiment, the tire 10e comprises a plurality of uniform tire knobs 20e. Preferably, the knobs 20e are identical in structure and aligned in the same direction. Each knob 20e comprises an asymmetrical pentahedron or a pyramid 23e defined by a rectangular bottom 28e, a pair of nonisosceles triangular surfaces 30e, 32e, a triangular end 22e, and an elongated triangular end 26e, wherein the surfaces 30e, 32e and the triangular ends 22e, 26e meet at the top at an apex point 29e.

The rectangular bottom, or base, 28e comprises a width 37e and a length 27e. Accordingly, the center of the base is where the midpoint of the width 37e and the midpoint of the length 27e meet. In this embodiment, each contact surface 29e comprises an apex 29e that is off-centered with respect to the rectangular bottom 28e.

The knobs 20e are arranged in rows such that the apex points 29e are linearly aligned in order to collectively form a dotted array of contact surfaces when the tire 10e meets the ground.

A first row of knobs 20e may be positioned end to end to form a linear array of contact surfaces 39-1e, which is adjacent to a second row of linearly aligned knobs 20e forming a second array of contact surfaces 39-2e. As illustrated in FIG. 13, in one embodiment, the first linear array of contact surfaces 39-le comprises a row of asymmetrical pyramids 23e oriented in the A-B direction, wherein an edge of the triangular end 22e of one asymmetrical pyramid 23e touches an edge of the elongated triangular end 26e of the adjacent asymmetrical pyramid 23e, creating a linear groove 24e between adjacent wedges 23e.

Further, a plurality of contact surfaces 39-1e, 39-2e are parallel in the A-B direction and touching each other, wherein an edge of the nonisosceles triangular surface 32e of one asymmetrical pyramid 23e abuts an edge of the nonisosceles triangular surface 30e of the adjacent asymmetrical pyramid 23e, creating a transversal groove 34e between adjacent wedges 23e. It can be appreciated that the combination of the linear groove 24e and the transversal groove 34e provide multiple channels to allow water and particles to pass through the channels and away from the surface of the tread to improve traction.

In an alternative preferred embodiment, a tire may be substantially similar to the fifth preferred embodiment except that the knobs are oriented in the C-D direction, namely perpendicular to that of the eighth embodiment.

The following preferred embodiments of a tire with contact surfaces present more complex patterns that combine the different orientations of tire knobs and contact surface points and lines. For illustration purposes only and not as a limitation, knobs having similar shape and elements as the symmetrical wedge 23 described in the first embodiment above will be used in these subsequent embodiments. It is to be understood that knobs of any geometric shape, length and size can be used uniformly or in different combinations throughout the tire tread in the following preferred embodiments described below.

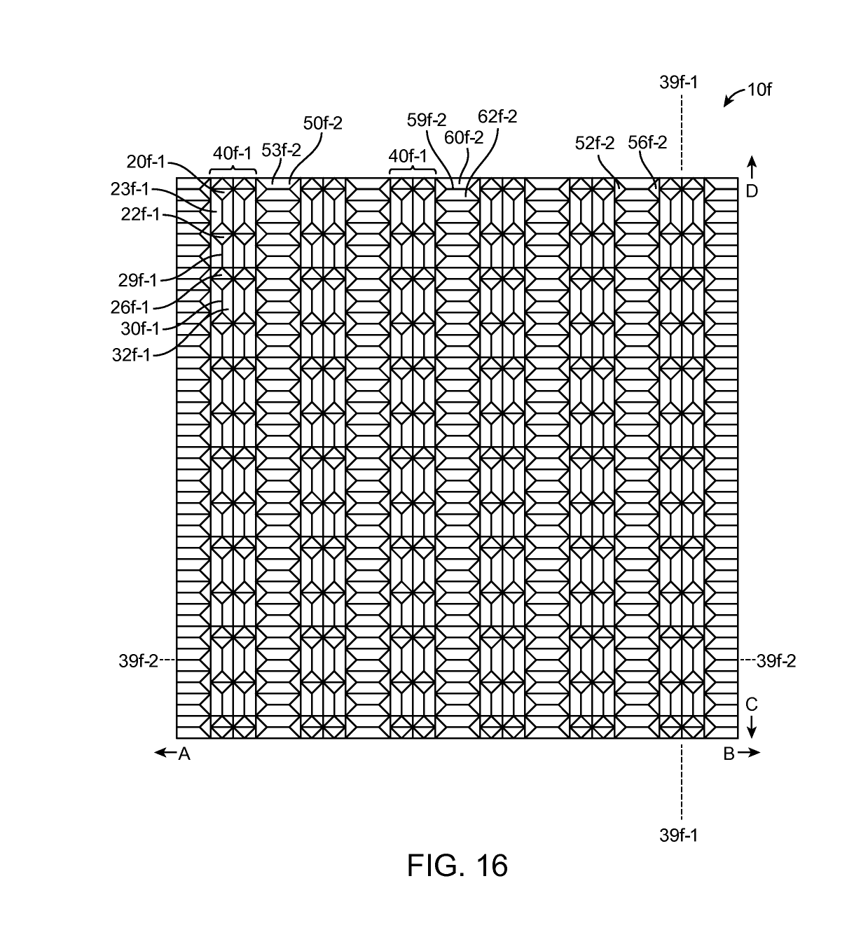

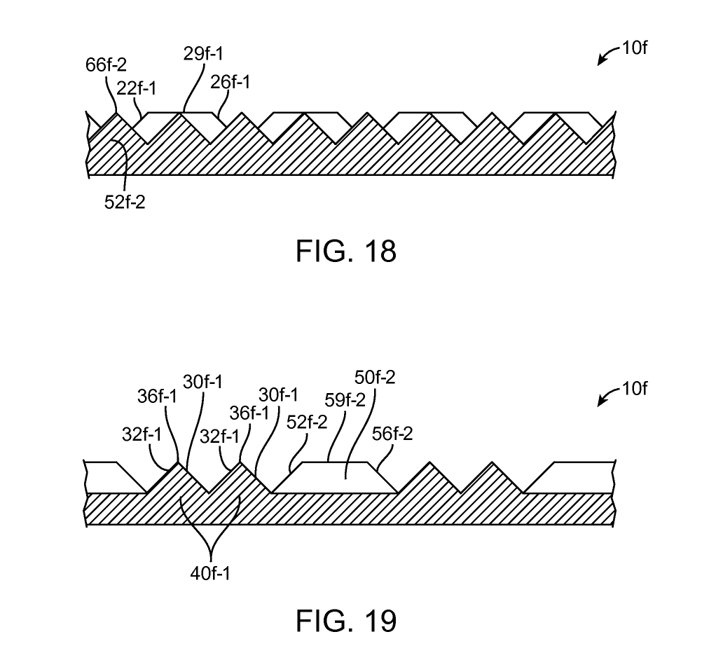

FIGS. 16-19 illustrate a sixth preferred embodiment of a tire 10f, where elements of similar structure are designated by the same reference numerals followed by the lower case “f.”

In this embodiment, the tire 10f comprises a first plurality of tire knobs 20f-1 preferably identical in structure and aligned in a first C-D direction and a second plurality of tire knobs 50f-2 preferably identical in structure and aligned in a second A-B direction that is not parallel to the first direction. For illustration purposes and not as a limitation, each first knob 20f-1 comprises a geometric wedge 23f-1 similar to the symmetrical wedge 23 described in the first embodiment above, where elements of similar structure are designated by the same reference numerals followed by the lower case “f.” Further, each first knob 20f-1 may preferably be positioned adjacent to another first knob 20f-1 to form a pair of first knobs 40f-1.

As shown in FIG. 16, a first row of C-D knobs 20f-1 may be positioned end to end in the C-D direction to form a first plurality of segmented contact surface lines 39f-1, which are perpendicular to a second plurality of segmented contact surface lines 39f-2. The first plurality of segmented contact surface lines 39f-1 are parallel in the C-D direction, while the second plurality of segmented contact surface lines 39f-2 are parallel in the A-B direction.

Similarly, each A-B knob 50f-2 comprises a geometric wedge 53f-2 defined by a rectangular bottom 58f-2, a pair of quadrilateral surfaces 60f-2, 62f-2 that meet at the top to form a ridge 59f-2, along with a pair of triangular ends 52f-2, 56f-2. The triangular ends 22f-2, 26f-2 have respective apexes 66f-2, 68f-2 that are connected by the ridge 59f-2. The ridge 59f-2 forms the point of contact of the tire 10f-2 with a ground surface. Unlike the second knobs 20f-2, each second knob 50f-2 is oriented in the A-B direction.

Further, unlike the A-B knobs 20f-1, the C-D knobs 50f-2 are positioned side to side in the C-D direction to form segmented contact surface lines 39f-2 in the C-D direction. In other words, in this configuration, an edge of the quadrilateral surface 62f-2 of one symmetrical wedge 53f-2 abuts an edge of the quadrilateral surface 60f-2 of the adjacent symmetrical wedge 53f-2 in the C-D direction.

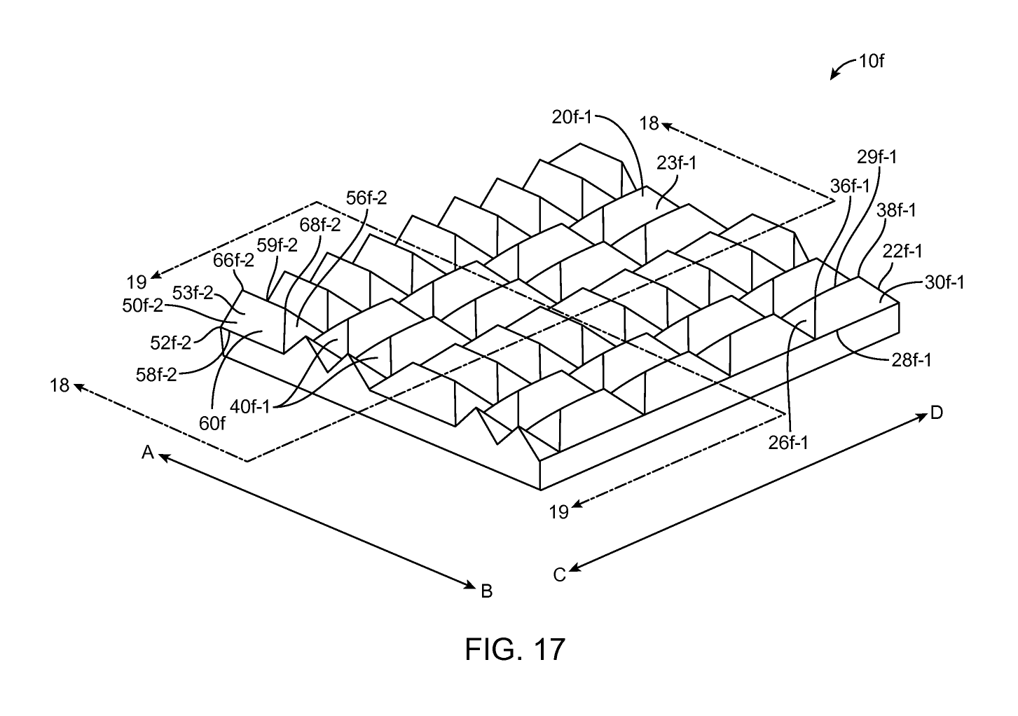

As shown in FIGS. 16-17, a plurality of the first segmented contact surface lines 39-f1 and the second segmented contact surface lines 39-f2 are positioned adjacent to the a plurality of the third segmented contact surface lines 39-f3, such that the first knobs 20f-1 and the second knobs 50f-2 are substantially perpendicular to each other.

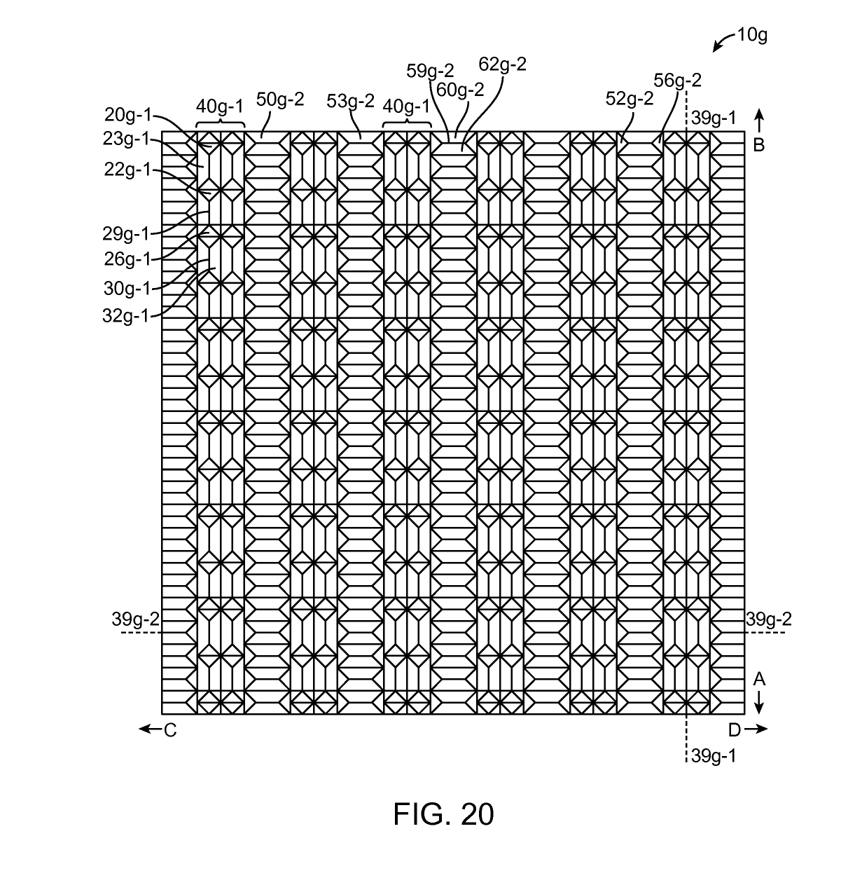

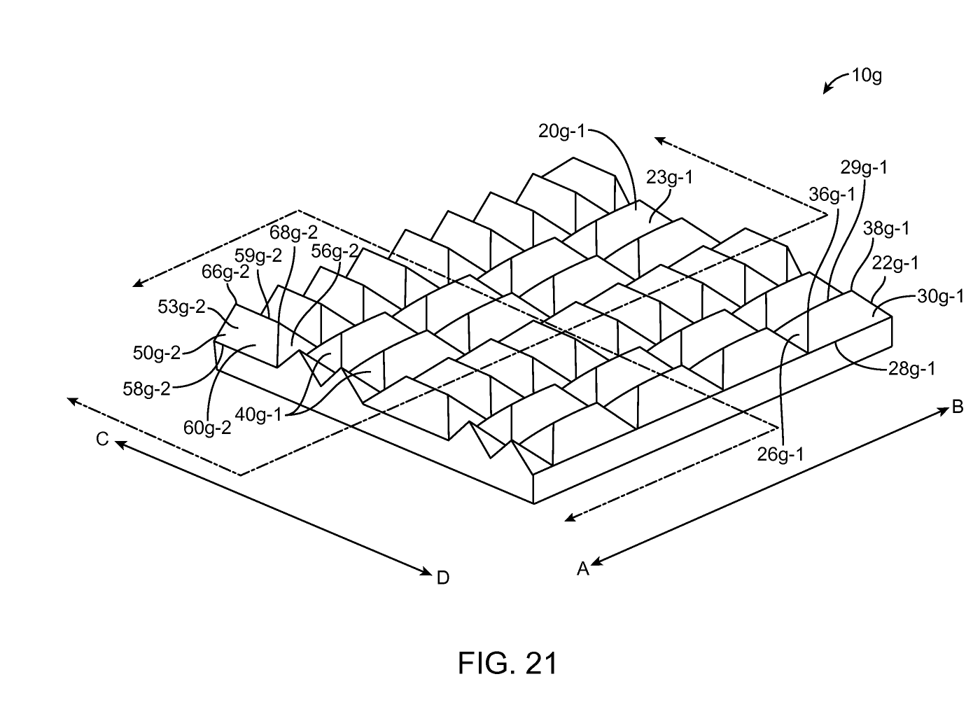

FIGS. 20-21 illustrate a seventh preferred embodiment of a tire with segmented contact surface 10g, where elements of similar structure are designated by the same reference numerals followed by the lower case “g.”

In this embodiment, the tire 10g comprises a first plurality of A-B tire knobs 20g-1 preferably identical in structure and aligned in a first A-B direction and a second plurality of C-D tire knobs 50g-2 are preferably identical in structure and aligned in a second C-D direction that is not parallel to the first direction. For illustration purposes and not as a limitation, each first knob 20g-1 comprises a geometric wedge 23g-1 similar to the symmetrical wedge 23 described in the first embodiment above, where elements of similar structure are designated by the same reference numerals followed by the lower case “g.” Further, each first knob 20g-1 may preferably be positioned adjacent to another first knob 20g-1 to form a pair of first knobs 40g-1.

As shown in FIG. 20, the first plurality knobs 20g-1 may be positioned end to end in the A-B direction to form a first plurality of segmented contact surface lines 39g-1, which are non-parallel to a second plurality of segmented contact surface lines 39g-2. In this embodiment, the first plurality of segmented contact surface lines 39g-1 are preferably perpendicular to the second plurality of segmented contact surface lines 39g-2.

For illustration purposes and not as a limitation, each C-D knob 50g-2 comprises a geometric wedge 53g-2 similar to the symmetrical wedge 53f-2 described above, where elements of similar structure are designated by the same reference numerals followed by the lower case “g.” As shown in FIG. 20, each C-D knob 50g-2 is oriented in the C-D direction.

The second knobs 50g-2 are positioned side to side in the A-B direction to form a third segmented contact surface line 39-3g. In other words, in this configuration, an edge of the quadrilateral surface 62g-2 of one symmetrical wedge 53g-2 abuts an edge of the quadrilateral surface 60g-2 of the adjacent symmetrical wedge 53g-2 in the A-B direction.

As shown in FIGS. 20-21, a plurality of the first segmented contact surface lines 39-1g and the second segmented contact surface lines 39-2g are positioned adjacent to the a plurality of the third segmented contact surface lines 39-3g, such that the first knobs 20g-1 and the second knobs 50g-2 are substantially perpendicular to each other.

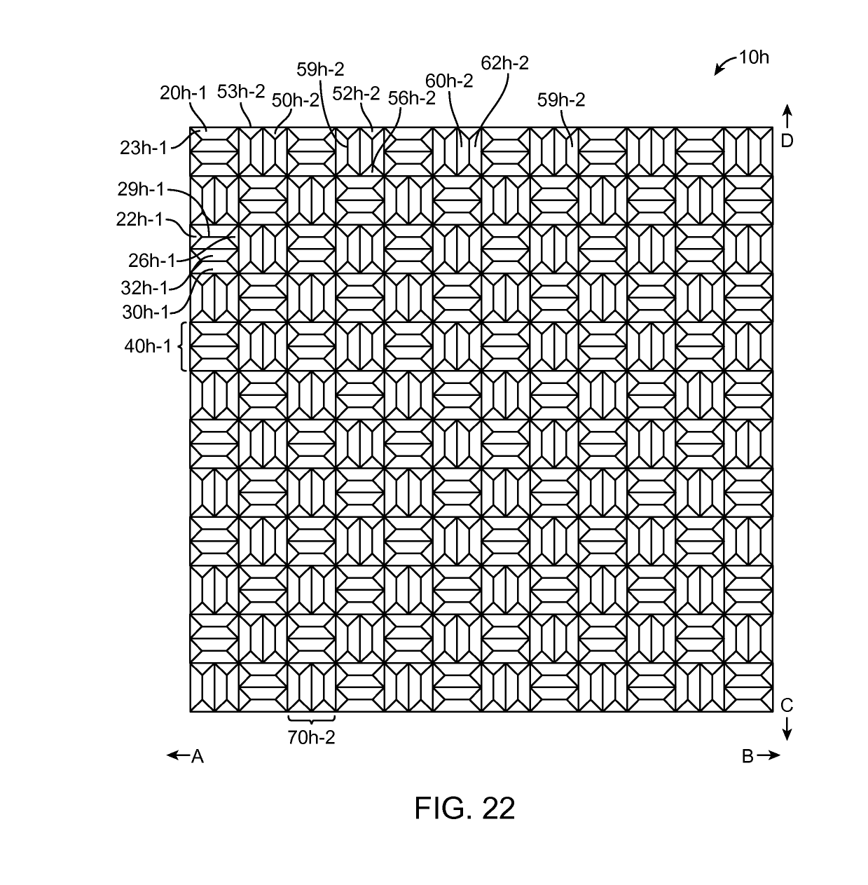

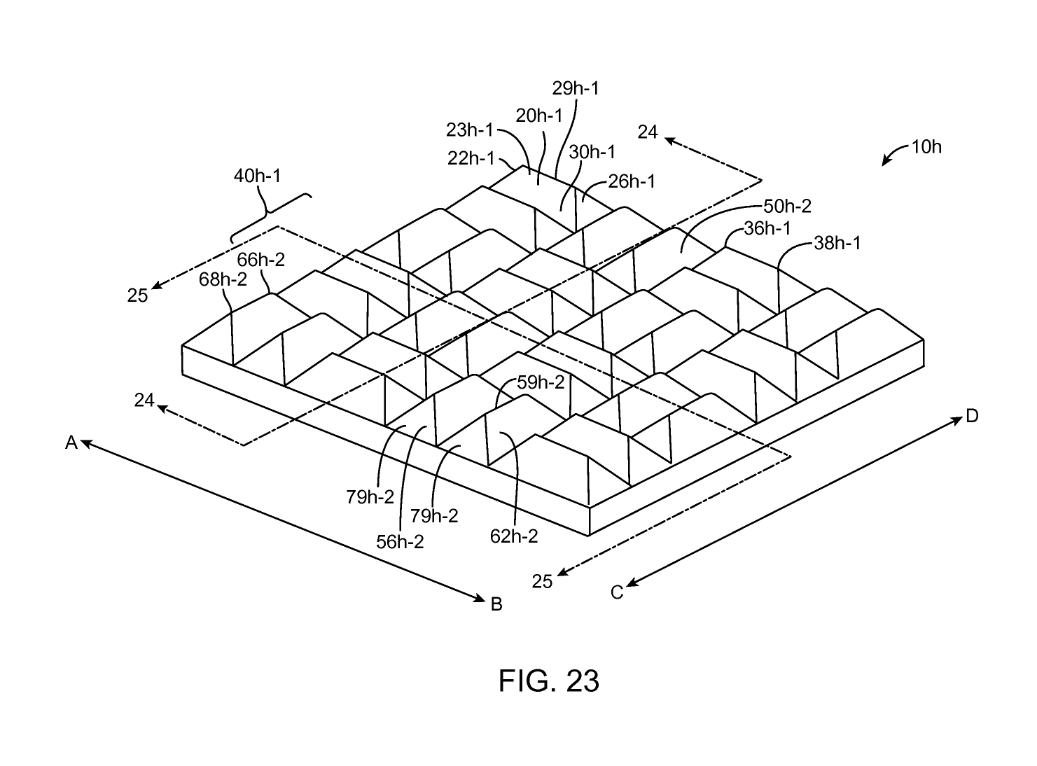

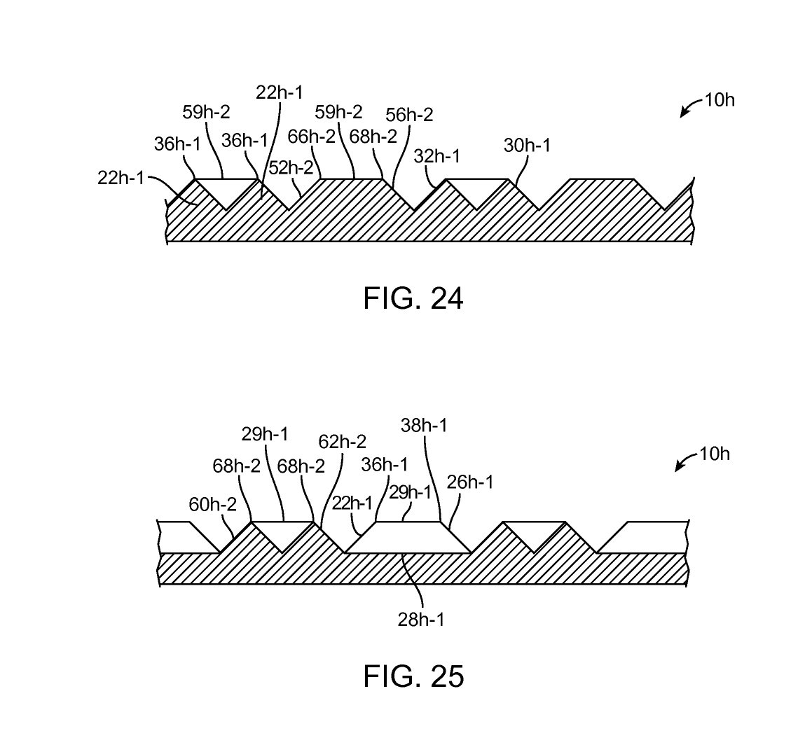

FIGS. 22-25 illustrate an eighth preferred embodiment of a tire 10h, where elements of similar structure are designated by the same reference numerals followed by the lower case “h.”

In this embodiment, the tire 10h comprises a first plurality of tire knobs 20h-1 preferably identical in structure and aligned in a first A-B direction and a second plurality of tire knobs 50h-2 preferably identical in structure and aligned in a second C-D direction that is not parallel to the first direction. Each knob 20h-1 comprises a geometric wedge 23h similar to the symmetrical wedge 23 described in the first embodiment above. Similarly, each C-D knob 50h-2 comprises a geometric wedge 53h-2 similar to the symmetrical wedge 53f-2 described above, where elements of similar structure are designated by the same reference numerals followed by the lower case “g.” According to a preferred embodiment, a first pair 40h-1 of first knobs 20h-1 is positioned adjacent to each other side to side in the A-B direction, wherein the edges of their respective quadrilateral surfaces are touching each other. Similarly, a second pair 70h-2 of second knobs 50h-2 is positioned in the C-D direction, wherein the edges of their respective quadrilateral surfaces are touching each other. The first pair 40h-1 and the second pair 70h-2 are positioned adjacent to each other, such that abutting first knobs 20h-1 and second knobs 50h-2 are substantially perpendicular to each other. Consequently, a plurality of abutting first pair 40h-1 and second pair 70h-2 provides a tire tread having an interwoven matrix that significantly improves traction with a ground surface.

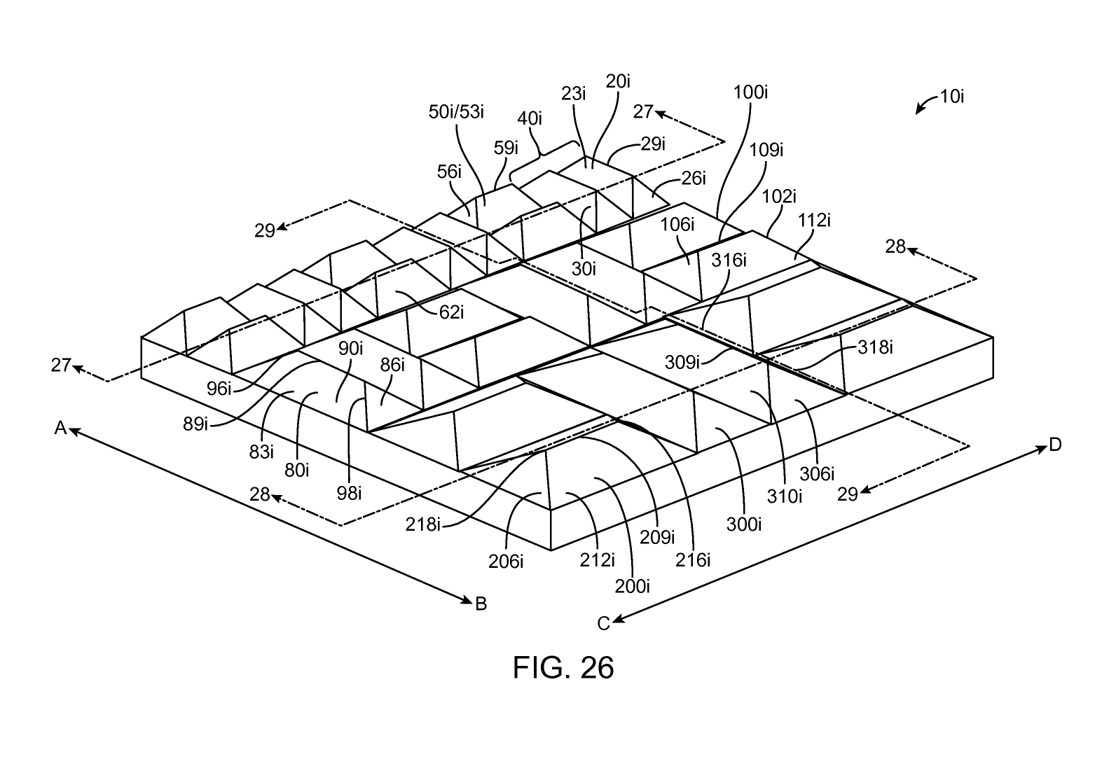

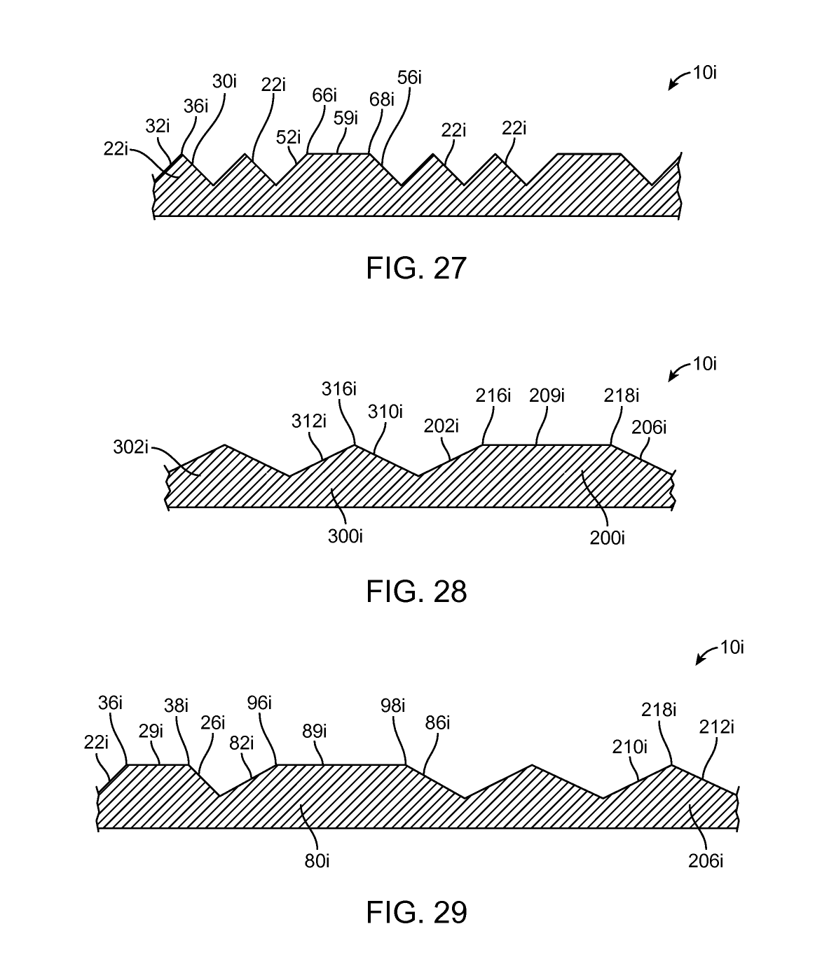

FIGS. 26-30 illustrate a ninth preferred embodiment of a tire 10i, where elements of similar structure are designated by the same reference numerals followed by the lower case “i.”

In this embodiment, the tire 10i comprises a first plurality of tire knobs 20i aligned in a first A-B direction, a second plurality of tire knobs 50i in a second C-D direction that is not parallel to the first A-B direction, a third plurality of tire knobs 80i aligned in the first A-B direction, a fourth plurality of fourth tire knobs 100i in the second C-D direction, a fifth plurality of tire knobs 200i in the second C-D direction and a sixth plurality of tire knobs 300i in the first A-B direction.

For illustration purposes and not as a limitation, each of the knobs 20i, 50i, 80i, 100i, 200i, and 300i comprises a geometric wedge similar to the symmetrical wedge 23 described in the first embodiment above. For instance, each first knob 20i comprises a geometric wedge 23i defined by a rectangular bottom 28i, a pair of quadrilateral surfaces 30i, 32i that meet at the top to form a ridge 29i, along with a pair of triangular ends 22i, 26i. The triangular ends 22i, 26i have respective apexes 36i, 38i that are connected by the ridge 29i. The ridge 29i forms the point of contact of the tire 10i with a ground surface. Preferably, each first knob 20i is positioned adjacent to another first knob 20i to form a first pair of knobs 40i.

Similarly, each second knob 50i comprises a geometric wedge 53i defined by a rectangular bottom 58i, a pair of quadrilateral surfaces 60i, 62i that meet at the top to form a ridge 59i, along with a pair of triangular ends 52i, 56i. The triangular ends 52i, 56i have respective apexes 66i, 68i that are connected by the ridge 59i. The ridge 59i forms the point of contact of the tire 10i with a ground surface. Preferably, each second knob 50i is positioned adjacent to another second knob 50i to form a second pair of knobs 70i.

Each third knob 80i comprises a geometric wedge 83i defined by a rectangular bottom 88i, a pair of quadrilateral surfaces 90i, 92i that meet at the top to form a ridge 89i, along with a pair of triangular ends 82i, 86i. The triangular ends 82i, 86i have respective apexes 96i, 98i that are connected by the ridge 89i. The ridge 89i forms the point of contact of the tire 10i with a ground surface. Preferably, each third knob 80i is positioned adjacent to another third knob 80i to form a third pair of knobs 81i.

Each fourth knob 100i comprises a geometric wedge 103i defined by a rectangular bottom 108i, a pair of quadrilateral surfaces 110i, 112i that meet at the top to form a ridge 109i, along with a pair of triangular ends 102i, 106i. The triangular ends 102i, 106i have respective apexes 116i, 118i that are connected by the ridge 109i. The ridge 109i forms the point of contact of the tire 10i with a ground surface. Preferably, each fourth knob 100i is positioned adjacent to another fourth knob 100i to form a fourth pair of knobs 101i.

Each fifth knob 200i comprises a geometric wedge 203i defined by a rectangular bottom 208i, a pair of quadrilateral surfaces 210i, 212i that meet at the top to form a ridge 209i, along with a pair of triangular ends 202i, 206i. The triangular ends 202i, 206i have respective apexes 216i, 218i that are connected by the ridge 209i. The ridge 209i forms the point of contact of the tire 10i with a ground surface. Preferably, each fifth knob 200i is positioned adjacent to another fifth knob 200i to form a fifth pair of knobs 201i.

Each sixth knob 300i comprises a geometric wedge 303i defined by a rectangular bottom 308i, a pair of quadrilateral surfaces 310i, 312i that meet at the top to form a ridge 309i, along with a pair of triangular ends 302i, 306i. The triangular ends 302i, 306i have respective apexes 316i, 318i that are connected by the ridge 309i. The ridge 309i forms the point of contact of the tire 10i with a ground surface. Preferably, each sixth knob 300i is positioned adjacent to another sixth knob 300i to form a sixth pair of knobs 301i.

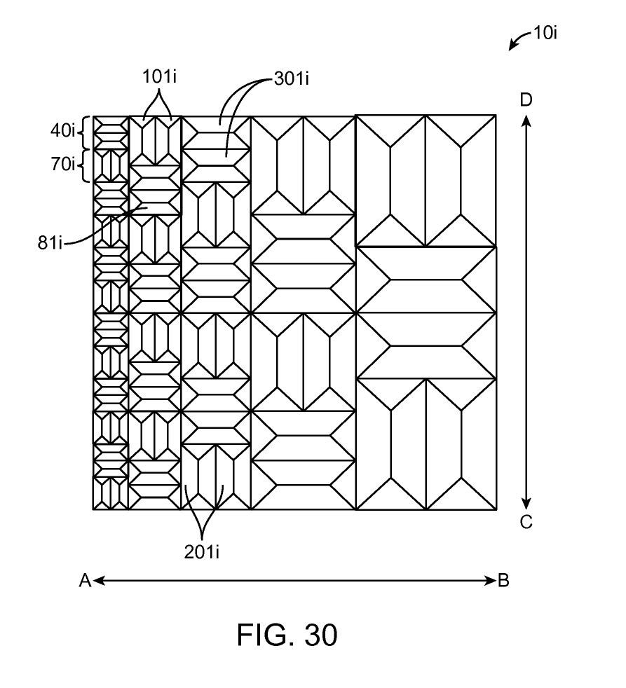

As readily seen in FIGS. 26 and 30, the knobs vary significantly in length and size, including the height of the contact surfaces relative to those of adjacent knobs. In a preferred embodiment, the first knobs 20i and the second knobs 50i are of the same length and size relative to each other, the third knobs 80i and the fourth knobs 100i are of the same length and size relative to each other, and the fifth knobs 200i and the sixth knobs 300i are of the same length and size relative to each other. By way of example and not as a limitation, the first knobs 20i and the second knobs 50i are the shortest in length and smallest in size, while the fifth knobs 200i and the sixth knobs 300i are the longest in length and largest in size. Referring to FIGS. 26-30, it should be noted that although the knobs have varying length and sizes, they may maintain the same height or have different heights. Further, it can be appreciated that the varying length, size and orientation of the knobs provide effective channels to allow water to pass through the channels and away from the surface of the tread to improve traction of the tire 10i.

According to a preferred embodiment, the knobs 20i, 50i, 80i, 100i, 200i, and 300i are positioned in a similar alternating fashion as the eighth embodiment described above. For example, as illustrated in FIGS. 26 and 30, the first pair of knobs 40i is oriented in the A-B direction, abutting the second pair of knobs 70i oriented in the C-D direction on one end and the fourth pair of knobs 101i oriented in the C-D direction on another end. In this configuration, a plurality of abutting knobs provides a tire tread having an intricate interwoven matrix of varying lengths and sizes that provides excellent traction with a ground surface.

It is to be understood that in an alternative embodiment, the respective orientations of the knobs in the above ninth embodiment can be reversed. For example, the first plurality of knob pairs can be oriented in the C-D direction, while the second plurality of knob pairs can be oriented in the A-B direction and so forth.

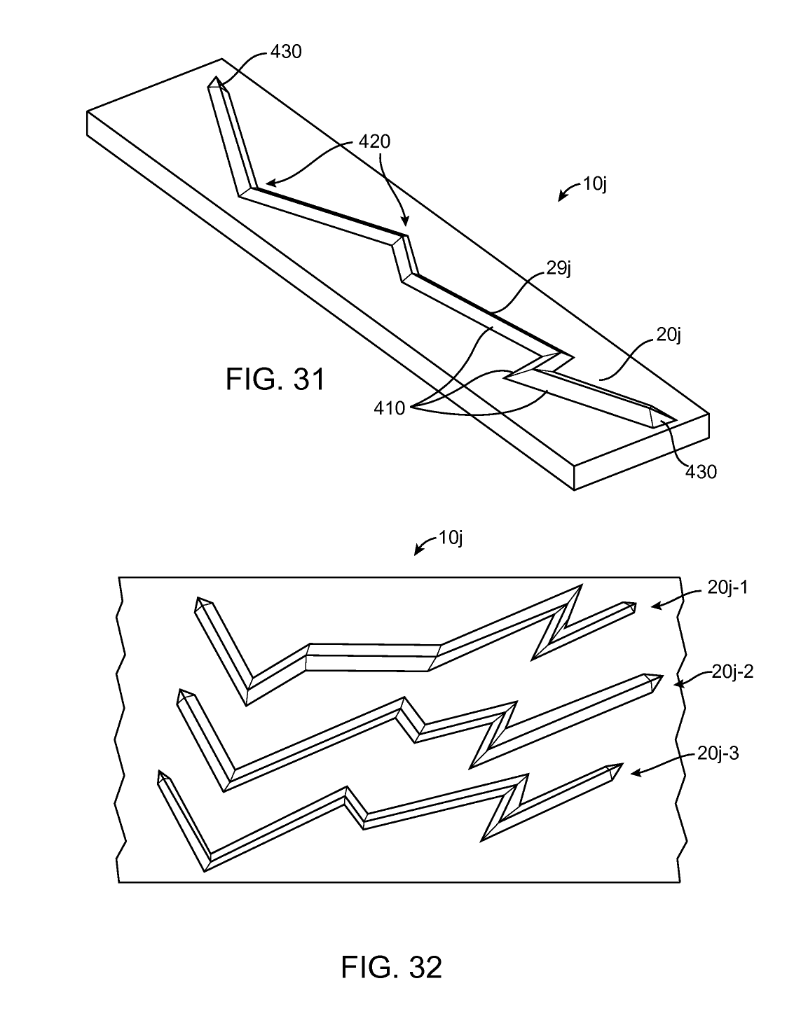

FIGS. 31-32 illustrate a tenth preferred embodiment of a tire 10j where elements of similar structure are designated by the same reference numerals followed by the lower case “j.” In this preferred embodiment, a tire knob 20j comprises linear wedge segments 410 connected at joints 420, where connected adjacent segments 410 at a joint 420 are oriented at an offset angle with respect to each other to form a zig-zag pattern. Thus, joined segments 410 are preferably not aligned or parallel to each other.

Each wedge segment 410 has a different length and comprises a corresponding linear contact surface, or ridge 29j. For example, wedge segment 410-1 has a greater length than the length of wedge segment 410-2. Accordingly, the corresponding ridges 29j-1, 29j-2 have different lengths and join together at each joint 420 to collectively form a connected, or joined, zig-zag contact surface 440 that is terminated at the ends 430.

In the top view of FIG. 32, a tire 10j may comprise multiple zig-zag knobs 20j-1, 20j-2, 20j-3 where each knob has its own distinctive zig-zag pattern.

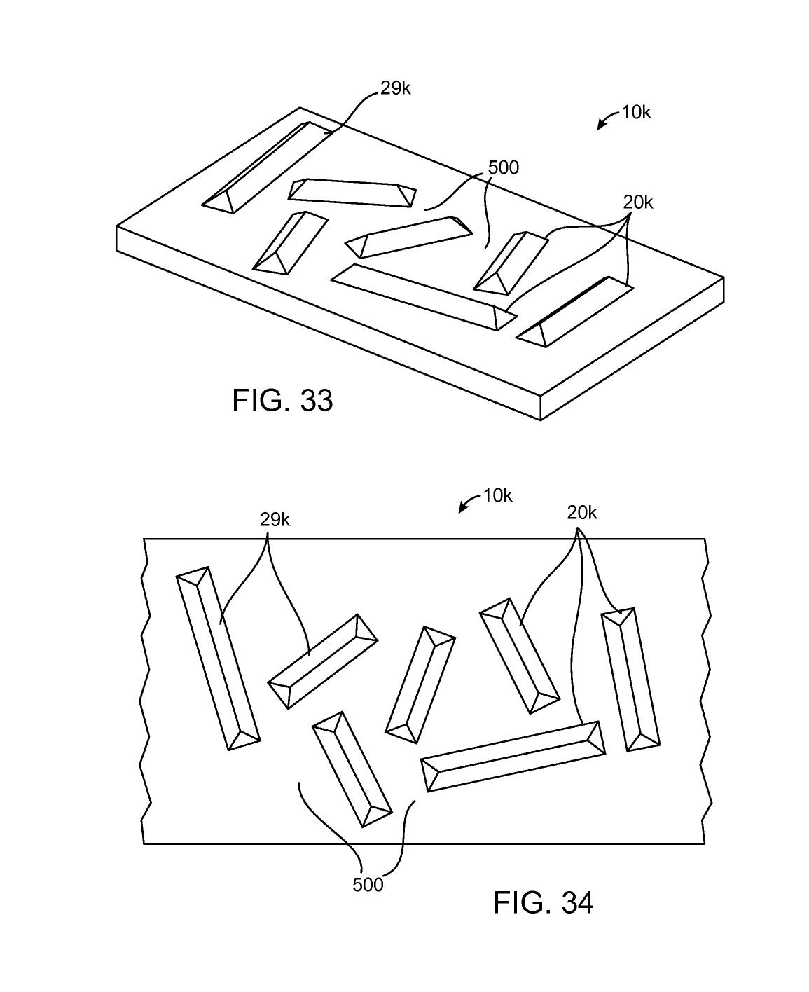

FIGS. 33-34 illustrate an eleventh preferred embodiment of a tire 10k where elements of similar structure are designated by the same reference numerals followed by the lower case “k.” In this preferred embodiment, the tire 10k comprises detached, individual elongate knobs 20k. Though each knob 20k is generally elongate with a wedge structure leading to a linear contact surface 29k, the individual knob 20k may have its own length and its own orientation, or angle, with respect to adjacent knobs 20k. The end result is a pattern of detached, linear contact surfaces 29k oriented in non-parallel directions and angles, and separated by gaps 500.

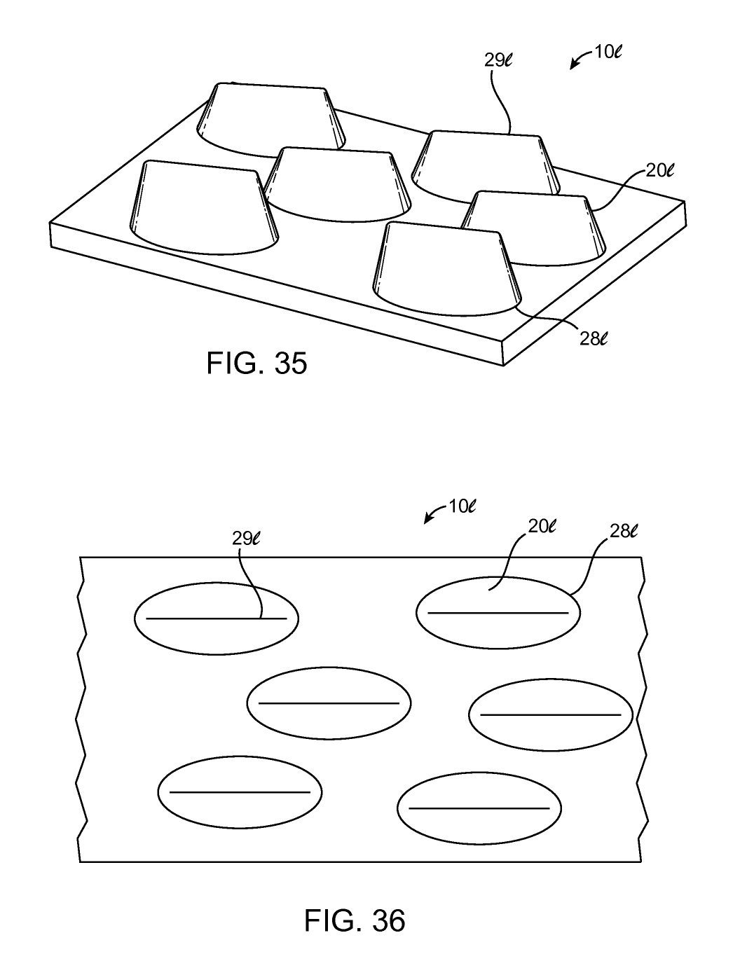

FIGS. 35-36 illustrate a twelfth preferred embodiment of tire 10l where elements of similar structure are designated by the same reference numerals followed by the lower case “l.” In this preferred embodiment, the tire 10l comprises detached, individual knobs 20l, where the knob base 281 forms a non-rectangular shape, such as an oval. Each knob 20l has a tapered structure leading to a linear contact surface, or ridge, 29l. The contact surfaces 29l are preferably aligned to form parallel, segmented contact surface lines.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A bicycle tire, comprising:
a first segmented contact surface line; and
a second segmented contact surface line.

2. The bicycle tire of claim 1, wherein:
the first segmented contact surface line is oriented in a first direction; and
the second segmented contact surface line is oriented in a second direction that is not parallel to the first direction.

3. The bicycle tire of claim 2, wherein:
the second segmented contact surface line is substantially perpendicular to the first segmented contact surface line.

4. The tire of claim 1, wherein:
the first segmented contact surface line has a first length; and
the second segmented contact surface line has a second length longer than the first length.

5. The tire of claim 1, wherein each of the first segmented contact surface line and the second segmented contact surface line further comprises a geometric wedge defined by a rectangular bottom, a pair of quadrilateral surfaces that meet at the top to form a ridge, a pair of triangular ends and the ridge is in contact with a ground.

6. The tire of claim 1, further comprising:
a first knob that comprises a first linear contact surface;
a second knob that comprises a second linear contact surface;
a third knob that comprises a third linear contact surface; and
a fourth knob that comprises a fourth linear contact surface,
wherein the first linear contact surface and the second linear contact surface are aligned and collectively form the first segmented contact surface line, and
wherein the third linear contact surface and the fourth linear contact surface are aligned and collectively form the first segmented contact surface line

7. The tire of claim 6, wherein:
the first knob includes a base defining a base length, a base width, and a center; and
the first linear contact surface is off-centered with respect to a center of the base.

8. A bicycle tire, comprising:
a first contact surface segment comprising a first ridge;
a second contact surface segment comprising a second ridge joined to the first ridge at a first offset angle; and
a third contact surface segment comprising a third ridge joined to the second ridge at a second offset angle.

9. The tire of claim 8, wherein the first contact surface segment has a first length, and the second contact surface segment has a second length longer than the first length.

10. The tire of claim 8, wherein the first contact surface segment, the second contact surface segment and the third contact surface segment join to form a zig-zag pattern.

11. The tire of claim 8, wherein:
the first contact surface segment is included in a first wedge; and
the second contact surface segment is included in a second wedge joined to the first wedge.

12. A bicycle tire, comprising:
a first knob having contact surface line having a first length and being oriented in a first direction;
a second knob contact surface line having a second length and oriented in a second direction not parallel to the first direction,
wherein the second contact surface line is detached from the first contact surface line, and
wherein the first length is greater than the second length.

13. The bicycle tire of claim 12, wherein:
the first knob comprises a first wedge; and
the second knob comprises a second wedge detached from the first wedge.

14. A bicycle tire, comprising:
a knob base defining a length, a width, and a center where a first midpoint of the length meets a second midpoint of the width; and
a contact surface that is off-centered with respect to the center of the base.

15. The tire of claim 14, further comprising a pair of asymmetrical quadrilateral surfaces that extend up to meet at the contact surface line.

16. The tire of claim 14, wherein the contact surface comprises an apex.

17. The tire of claim 14, wherein the contact surface comprises a line.
